(19) United States
(12) Patent Application Publication
(10) Pub. No.: US 2026/0220014 A1
(43) Pub. Date: Jul. 30, 2026

(54) BENCHMARKING AND SEGMENT-BASED PREDICTION OF ARTIFICIAL INTELLIGENCE MODEL INFERENCE CHARACTERISTICS ON LOCAL DEVICES

(71) Applicant: DELL PRODUCTS L.P., Round Rock, TX (US)

(72) Inventors: Spencer Bull, Conroe, TX (US); Tyler Cox, Austin, TX (US); Jacob Mink, Cedar Park, TX (US); Srikanth Kondapi, Austin, TX (US)

(21) Appl. No.: 19/036,323

(22) Filed: Jan. 24, 2025

(51) Int. Cl. G06F 11/34

(52) U.S. Cl. CPC G06F 11/3428; G06F 11/3433; G06F 11/3457

(57) ABSTRACT

An information handling system receives a request for an artificial intelligence service that is associated with an artificial intelligence model and retrieves a manifest associated with the artificial intelligence model. The system also determines a current system capacity of the information handling system and determines a workload segmentation according to the manifest based on the current system capacity of the information handling system.

### FIELD OF THE DISCLOSURE

The present disclosure generally relates to information handling systems, and more particularly relates to benchmarking and segment-based prediction of artificial intelligence model inference characteristics on local devices.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may receive a request for an artificial intelligence service that is associated with an artificial intelligence model and retrieve a manifest associated with the artificial intelligence model. The system also may determine a current system capacity of the information handling system and determine a workload segmentation according to the manifest based on the current system capacity of the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an environment for benchmarking and segment-based prediction of artificial intelligence model inference characteristics on local devices, according to an embodiment of the present disclosure;

FIG. 2 is a flowchart of a method for lifecycle management and benchmarking of an artificial intelligence model, according to an embodiment of the present disclosure;

FIG. 3 is a flowchart of a method for client-side utilization of a manifest which is an output of the benchmarking, according to an embodiment of the present disclosure; and

FIG. 4 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

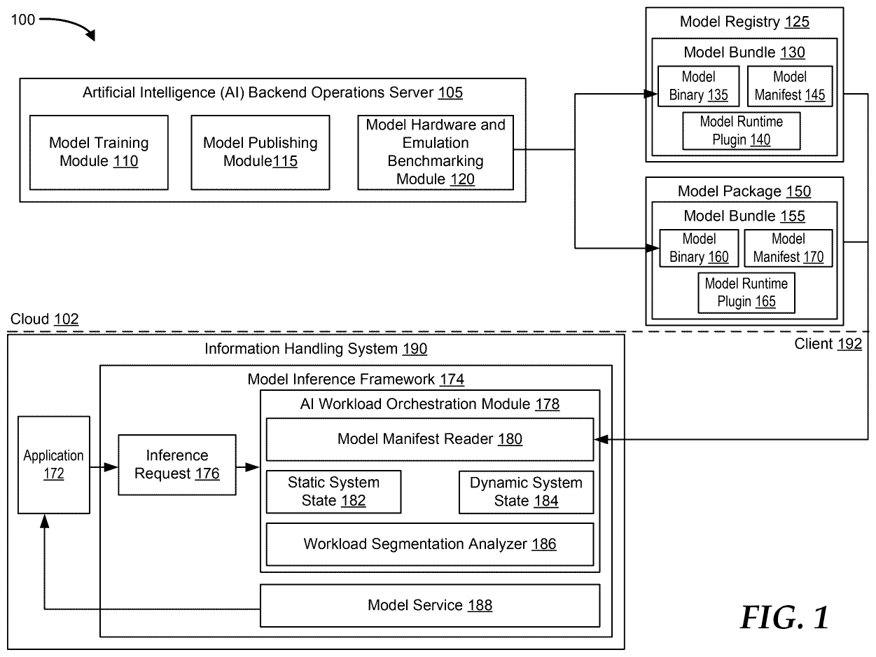

FIG. 1 illustrates a portion of an environment 100 for benchmarking and segment-based prediction of artificial intelligence model inference characteristics on local devices, according to an embodiment of the present disclosure. Environment 100 includes a cloud 102 and client 192. Cloud 102 includes an artificial learning (AI) backend operations server 105 that further includes a model training module 110, a model publishing module 415, and a model hardware and emulation benchmarking module 120. Client 192 includes an information handling system 190 that further includes an application 172 and a model inference framework 174. AI backend operations server 105 in cloud 102 may be communicatively coupled to information handling system 190 through a network. However, any variety of connections between AI backend operations server 105 and information handling system 190 are envisioned as falling within the scope of the present disclosure. In addition, connections between components may be omitted for descriptive clarity. The operations described herein as being performed by one or more components of AI backend operations server 105 and information handling system 190 may be performed by a processor.

The network may be a public network, such as the Internet, a physical private network, a wireless network, a virtual private network, or any combination thereof. The network may be implemented as or may be a part of, a storage area network, a personal area network, a local area network, a metropolitan area network, a wide area network, a wireless local area network, an intranet, or any other appropriate architecture or system that facilitates the communication of signals, data, and/or messages.

Information handling systems generally process, compile, store, and/or communicate information or data for business, personal, or other purposes thereby allowing users to take advantage of the value of the information. Nevertheless, a continually growing number of information handling systems and devices are being enhanced with AI services, such as heuristic learning, machine learning, deep learning, reinforcement learning services, and the like. Currently, most AI services, such as AI model inference, are generally performed in central processing units (CPUs), graphics processing units (GPUs), system-on-chips (SOCs), neural processing units (NPUs), or other processors of the information handling system.

AI model inference may require an understanding of how an AI model, also referred to herein simply as a model, performs across diverse local device configurations and workloads to optimize user experience and system efficiency. The challenge lies in calculating accurate performance benchmarks, such as load time, inference time, tokens per second, and system user experience impact, across devices with varying specifications and utilization states as users and applications impact the system. Existing solutions generally do not provide a streamlined method to predict these characteristics dynamically on local devices, nor a mechanism to ensure benchmarks are readily available for local inference decisions. This creates inefficiencies in utilizing local device resources optimally. To address this issue and other concerns, the present disclosure provides a system and method for benchmarking and segment-based prediction of AI model inference characteristics on local devices.

In one example use case, a productivity application running on a user's laptop requires real-time artificial intelligence-driven assistance. The information handling system may ensure that the AI model is executed locally using what may be the most appropriate compute resource, such as whether to use a GPU versus a CPU or an NPU while adhering to constraints such as low latency and minimal impact on battery life. If the AI model is not available locally, it may be downloaded as a plugin from the cloud but may typically execute on the local device.

AI backend operations server 105 may be any system configured to optionally train, promote, and publish an AI model. Once published, the AI model may enter a benchmarking pipeline, such as model hardware and emulation benchmarking module 120. Model training module 110 may be any system configured to train an AI model using a training dataset. Model publishing module 115 may be any system configured to publish and promote the trained AI model, such that it is available for download and/or use.

Model hardware and emulation benchmarking module 120, also referred to herein simply as benchmarking module 120, may be any system configured to benchmark the trained AI model. Benchmarks may be run on real devices or a device emulation framework to simulate various system configurations, states, and workloads. Benchmarking module 120 may emulate diverse device configurations of CPUs, GPUs, and NPUs. Further, benchmarking module 120 may simulate workloads and utilization scenarios specific to local devices. For example, benchmarking module 120 may simulate background application workload and low power states. By using a device emulation framework and real devices, it simulates diverse user states to divide the workload into segments based on device specifications, system configuration, system utilization, and workload scenarios.

Benchmarking module 120 may be configured to calculate detailed performance benchmarks, including load time, inference time, and user experience impact, for various local device configurations and workloads based on the benchmarking process. This may be used to predict the performance and impact of the model inference when executed in a client device, such as information handling system 190. The division of the workload may be based on the calculated performance metrics. For example, the segmentation of workload for a first discrete system configuration, system utilization, and workload scenario may be different for a second discrete system configuration, system utilization, and workload scenario. The scenario may be from a highly utilized system to a low utilized system and variations in between. This allows for optimal workload segmentation for each system configuration, system utilization, and workload scenario. For example, a first segmented workload may process ten words for each segment for a highly utilized system, while a second segmented workload may process 5,000 for a low utilized system.

Benchmarking module 120 may then generate a manifest as an output of the benchmarking process based on the calculated performance metrics. The manifest may include information on the different workload segmentation and associated system configuration, system utilization, and workload scenarios, such as model manifests 145 and 170. The manifest may also include information regarding load time, inference time, tokens per second, and system user experience impact under various local conditions, among others.

The manifest may be distributed or made available through cloud downloads, model runtime plugins, and policy-based distribution. For example, the manifest may be included in a model bundle for download from a registry or as part of a pre-packaged model. Finally, the manifest may be managed through enterprise policies to enforce uniformity across devices.

For example, a model registry 125 includes a model bundle 130 that further includes a model binary 135, a model runtime plugin 140, and model manifest 145. In one embodiment, the manifest may be embedded in a model runtime plugin. Model registry 125 may be configured to store AI models for download. Model bundle 130 may be a collection of software components packaged together as a single unit. Model binary 135 may include code or instructions that represent the AI model which can be executed via model runtime plugin 140. Model manifest 145 may have been generated by benchmarking module 120 and includes information as identified above.

In another example, a model package 150 may be a software package that includes a model bundle 155 that further includes a model binary 160, a model runtime 165, and a model manifest 170. Model package 150 may also include an installer. Model binary 160 is similar to model binary 135 while model runtime 165 is similar to model runtime plugin 140. Model manifest 170 may also be generated by benchmarking module 120 similar to model manifest 145.

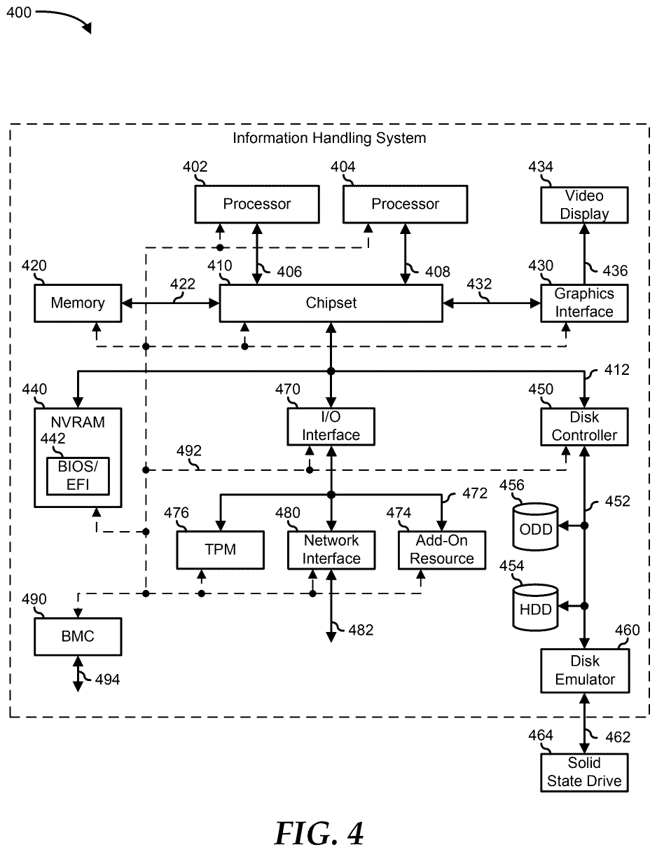

Information handling system 190, which is similar to information handling system 400 of FIG. 4, may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 190 may also be a portable information handling system that may include a laptop, a notebook, a smartphone, a tablet, or a personal digital assistant, among others. In one example, information handling system 190 may be an employee's corporate laptop.

Application 172 may be an AI-powered software, such as conversational AI applications, also referred to as chatbots or virtual assistants. Application 172 may also be a production AI-powered software where a trained AI model may be used to generate a conclusion on new data. For example, application 172 may be an email spam filter that uses a trained AI model to classify whether an incoming email is a spam or not. Application 172 may generate an inference request 176 and transmit inference request 176 to AI workload orchestration module 178 which is part of model inference framework 174.

Model inference framework 174 may include one or more software components that service application 172 for local AI model inference optimization based on prior benchmarking process and real-time manifest-driven prediction. AI workload orchestration module 178 may be configured to predict characteristics such as load time and inference time dynamically based on real-time utilization. The manifest may be parsed by model manifest reader 180, which may comprise any system, device, or apparatus configured to parse and/or analyze a manifest file. For example, model manifest reader 180 may match static system state 182 and the current state of dynamic system state 184 to a workload segmentation in the manifest that is associated with a similar or closest static system state and dynamic system state.

Static system state 182 may refer to the current processing capability or system configuration of information handling system 190. For example, static system state 182 may be based on what type of processing unit(s) that information handling system 190 currently has and associated performance metrics. The processing units may include one or more CPUs, GPUs, SOCs, or NPUs. Static system state 182 may also indicate whether the GPUs or NPUs are integrated or discrete. One performance metric that can be used may be operations per second of each processing unit. For example, NPUs are typically designed to handle AI models with large data input, including images and video.

Dynamic system state 184 may indicate the ability of the processing units to perform model inference at a particular time period. Dynamic system state 184 may be determined based on various factors, such as current utilization state, power state, currently downloaded hot AI models versus cold AI models, etc. For example, if there is an AI model currently loaded in memory, then dynamic system state 184 may be lower than when there is no AI model in memory.

Workload segmentation analyzer 186 may comprise any system, device, or apparatus that may be configured to determine a closest workload segmentation from the manifest based on the capability and capacity of the information handling system. For example, based on a prediction of AI workload orchestration module 178, workload segmentation analyzer 186 may determine a segmentation of the workload associated with the predicted characteristics that are closest to the current capability and capacity of information handling system 190. In particular, if the current capacity of information handling system 190 is low due to intensive processing at its CPU, then workload segmentation analyzer 186 may choose the workload segment that should be processed based on the specification from the manifest for low capacity scenarios, such as processing a lesser number of tokens than typical for language models. Otherwise, if the current capacity of information handling system 190 is typical, then workload segmentation analyzer 186 may choose default segmentation for the workload.

In one embodiment, after selecting the workload segmentation that is associated with a system state that approximately matches the current system state, model inference framework 174 may inform a local resource of selection for model execution for optimal performance and minimal system impact. For example, AI workload orchestration module 178 may select an NPU for model execution instead of a CPU or a GPU of the information handling system. However, if the NPU is currently executing another model, then AI workload orchestration module 178, then AI workload orchestration module 178 may select a processing unit, such as one of the CPU or GPU based on their capability and capacity. AI workload orchestration module 178 may notify model service 188 of the selection. Model service 188 may then perform the AI service, such as executing a model inference based on the segmented workload using the selected processing unit.

Those of ordinary skill in the art will appreciate that the configuration, hardware, and/or software components of environment 100 depicted in FIG. 1 may vary. For example, the illustrative components within AI backend operations server 105 and information handling system 190 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

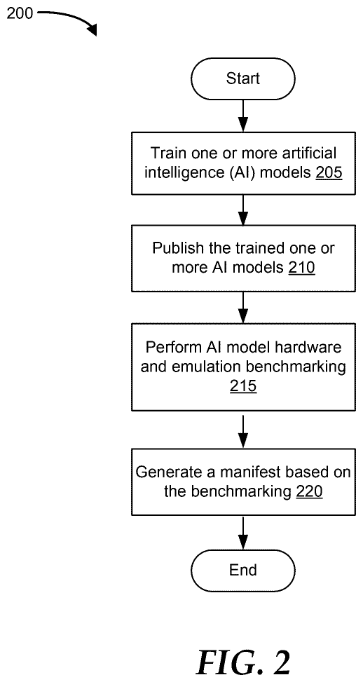

FIG. 2 illustrates a portion of a flow chart of a method 200 for lifecycle management and benchmarking of an artificial intelligence model, according to an embodiment of the present disclosure. Method 200 may be performed by one or more components of AI backend operations server 105 of FIG. 1, including but not limited to model training module 110, model publishing module 115, and benchmarking module 120. While embodiments of the present disclosure are described in terms of the components of AI backend operations server 105 of FIG. 1, it should be recognized that other components may be utilized to perform the described method. One of skill in the art will appreciate that this flow chart explains a typical example, which can be extended to applications or services in practice. It will be readily appreciated that not every operation set forth in this flow chart is always necessary and that certain operations may be combined, performed simultaneously, in a different order, or perhaps omitted, without varying from the scope of the disclosure. One of skill in the art will appreciate that this flow chart explains a typical example, which can be extended to applications or services in practice.

A framework for local artificial intelligence model inference optimization through benchmarking and manifest-driven prediction. The framework may be configured to calculate detailed performance benchmarks, including load time, inference time, and user experience impact, for various local device configurations and workloads. By using a device emulation framework and real devices, it simulates diverse user states to generate a manifest with information associated segmentation-based workload. The manifest is then distributed via cloud downloads, runtime plugins, or policy-based updates to ensure its availability for local inference. Unlike systems that rely on cloud offloading, this solution focuses on optimizing local device performance. The integration of segmentation-based prediction, manifest-driven optimization, and localized execution ensures that AI workloads are dynamically tailored to the specific device's real-time state, enhancing efficiency and user experience. This is done because model inference may be preferentially performed at a client device due to latency constraints of time-sensitive applications.

Method 200 typically starts at block 205 where one or more AI models are trained against a training dataset by a model training module. The method may proceed to block 210 where a trained AI model is published by a model publishing module. This makes the trained AI model available for use. In one embodiment, the trained AI model may be published as a binary at a model registry.

The method may proceed to block 215 where a model hardware and emulation benchmarking module performs a benchmarking process of the trained AI model. In one example, the benchmarking process may be performed in an emulated environment such as by using a virtual machine. The virtual machine is a software implementation of a physical machine, wherein the virtual machine can emulate system architecture to support the execution of an operation system and applications among others. Accordingly, the virtual machine may be used to emulate an AI-capable computing node of a particular capability and capacity. For example, a first virtual machine may emulate an AI-capable computing node with a CPU, GPU, and NPU at various configurations.

In addition, the benchmarking process may simulate workload and utilization scenarios specific to local devices, such as adding background applications, and low-power states. The benchmarking process may also simulate utilization scenarios, such as from a high utilization scenario to a low utilization scenario with variations in between. Metrics may be collected, such as load time, inference time, etc. to be used in each scenario. This is done to understand performance and determine optimal segmentation of the workload for each system configuration and capacity combination, which may be used in predicting inference time and impact on a system when a model inference is run at a particular system configuration and utilization.

The model hardware and emulation benchmarking module may segment a workload associated with a model based on a combined capability and capacity of an emulated AI-capable computing node. In particular, the number of segments for each workload instance may be determined for an optimal workload performance of a combined static system state, dynamic system state, and segmented workload. For example, the workload may be segmented, such that smaller data sets may be processed when the capacity of the AI-capable computing device is low. In comparison, the workload may be segmented, such that larger data sets may be processed when the capacity of the AI-capable computing device is higher. Information associated with the segmentation of the workload may be provided or stored in the manifest, wherein each segmented workload may tagged or associated with an optimal capability and capacity combination of a particular AI-capable computing device.

At block 220, the model hardware and emulation benchmarking module may generate a manifest. The manifest includes information discussed above, such as performance metrics of the benchmarking process associated with artificial model workloads in various scenarios. For example, the manifest may include load time, inference time, tokens per second, and system user experience impact under various local conditions and/or segmented workload. The segmented workload may be mapped to a discrete combination of static system state, dynamic system state, and workload.

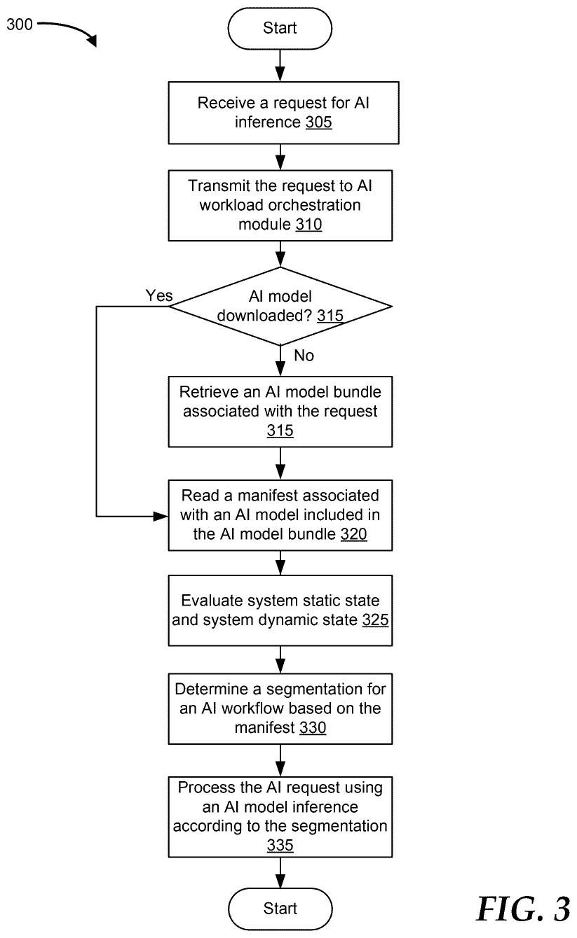

FIG. 3 illustrates a portion of a flow chart of a method 300 for manifest-driven optimization, and localized execution of AI workloads, according to an embodiment of the present disclosure. Method 300 may be performed by one or more components of information handling system 190 of FIG. 1 including but not limited to model inference framework 174, AI workload orchestration module 178, model manifest reader 180, workload segmentation analyzer 186, and model service 188 of FIG. 1. While embodiments of the present disclosure are described in terms of the components of information handling system 190 of FIG. 1, it should be recognized that other components may be utilized to perform the described method. One of skill in the art will appreciate that this flow chart explains a typical example, which can be extended to applications or services in practice. It will be readily appreciated that not every operation set forth in this flow chart is always necessary and that certain operations may be combined, performed simultaneously, in a different order, or perhaps omitted, without varying from the scope of the disclosure. One of skill in the art will appreciate that this flow chart explains a typical example, which can be extended to applications or services in practice.

Method 300 typically starts at block 305 where an information handling system may receive a request for an AI service, such as an AI model inference. For example, a user utilizing a productivity application that requires real-time AI assistance. As such, the productivity application may send a request for an AI model inference. The request may be received by an information handling system via a communication interface and provided to the model inference framework. For example, the request may be transmitted via an application programming interface (API), such as representational state transfer (REST), remote procedure call (RPC), etc. The model inference framework may then determine one or more properties associated with the AI model for the inference, such as the type and size of the model to be used, download location, etc. These properties may be based on preferences associated with the AI application.

At block 310, the model inference framework may transmit the request for AI model inference to the AI workload orchestration module. The method may proceed to block 315 where the AI workload orchestration module may determine whether the AI model has already been downloaded. If the AI model has not been downloaded, then the “NO” branch is taken, and the method may proceed to block 315. If the AI model has already been downloaded, then the “YES” branch is taken, and the method may proceed to block 320.

At block 315, the AI workload orchestration module may download a model bundle associated with the AI model for the inference task or service from a model registry. In another instance, the workload orchestration module may download a model package that includes the model bundle from a developer of the AI model. Typically, the model bundle includes a model binary, a model runtime, and a model manifest, which may be extracted and installed in the information handling system.

At block 320, a model manifest reader may parse and/or read the model manifest. In one embodiment, the downloaded model manifest may undergo parsing to validate its structure and content. In addition, the manifest reader may determine mappings of various workload segmentations to the system static state, system dynamic state, and workload scenarios. For example, a discrete workload segmentation may be mapped to a high utilization, medium utilization, and low utilization of an information handling system with a particular technical specification.

At block 325, the AI workload orchestration module may evaluate a local device's static system state and/or dynamic system state. The static system state may refer to the static capability of the local device while the dynamic system state may refer to the dynamic capacity of the local device. For example, to determine the static system state, the AI workload orchestration module may discover processing capabilities of the information handling system, such as architecture, operating system, system manufacturer, model, software dependencies, silicon properties, capabilities of AI processing chip(s), etc. For example, the AI workload orchestration module may determine the technical specification of the information handling system, such as the processing units of the information handling system, such as whether the information handling system includes one or a combination of a CPU, GPU, NPU, or similar.

In addition, the AI workload orchestration module may discover properties associated with each processing unit. For example, the AI workload orchestration module may determine whether the CPU is an Apple M1®/M2®, Intel i5®/i7®, Qualcomm Snapdragon®, etc. In addition, the AI workload orchestration module may determine a manufacturer of a CPU or GPU of the client device. For example, the AI workload orchestration module may determine whether the processing of the client device is manufactured by Intel®, AMD®, or Nvidia®. In another example, the AI workload orchestration module may determine whether the operating system of the information handling system is an Apple iOS®, Microsoft Windows®, Linux® OS, etc.

To determine the current dynamic state, the AI workload orchestration module may determine the current utilization of the local device, properties of downloaded AI models if any, information associated with model heuristics, current power state, current user workload, or workload state, among others.

The method may proceed to block 330, where the AI workload orchestration module may determine the closest segmentation of the workload for a system static state, system dynamic state, and workload scenario that matches or is similar to the current system static state and current system dynamic state. For example, if currently the local device has low utilization, the AI workload orchestration module may determine the workload segmentation in the manifest that is associated with low utilization for an information handling system that closely matches the system static state of the local device.

The method may proceed to block 335, where the AI workload orchestration module provides the selected segmented workload and AI model to a model inference runtime module for execution. The model inference runtime module may then provide results of the model inference to the application. Afterwards, the method ends.

FIG. 4 illustrates an embodiment of an information handling system 400 including processors 402 and 404, a chipset 410, a memory 420, a graphics adapter 430 connected to a video display 434, a non-volatile RAM (NVRAM) 440 that includes a basic input and output system/extensible firmware interface (BIOS/EFI) module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and a baseboard management controller (BMC) 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (x4) PCIe adapter, an eight-lane (x8) PCIe adapter, a 16-lane (x16) PCIe adapter, or another configuration, as needed or desired. In a particular embodiment, graphics adapter 430 is provided down on a system printed circuit board (PCB). Video display output 436 can include a DVI, a HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out-of-band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell® Remote Access Controller (iDRAC).

Management interface 492 represents one or more out-of-band communication interfaces between BMC 490 and the elements of information handling system 400 and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC, or the like. BMC 490 may operate on a separate power plane from other resources in information handling system 400. Thus, BMC 490 can communicate with the management system via network interface 494 while the resources of information handling system 400 are powered off. Here, information can be sent from the management system to BMC 490 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional busses, not shown for clarity. For example, information handling system 400 can include multiple processor cores, audio devices, and the like. While a particular arrangement of bus technologies and interconnections is illustrated for the purpose of example, one of skill will appreciate that the techniques disclosed herein are applicable to other system architectures. Information handling system 400 can include multiple central processing units (CPUs) and redundant bus controllers. One or more components can be integrated together. Information handling system 400 can include additional buses and bus protocols, for example, I²C and the like. Additional components of information handling system 400 can include one or more storage devices that can store machine-executable code, one or more communications ports for communicating with external devices, and various input and output (I/O) devices, such as a keyboard, a mouse, and a video display.

For purposes of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as a System-on-a-Chip (SoC), or other control logic hardware. Information handling system 400 can also include one or more computer-readable media for storing machine-executable code, such as software or data.

Although FIG. 2, and FIG. 3 show example blocks of method 200 and method 300 in some implementations, method 200 and method 300 may include additional blocks, fewer blocks, different blocks, or differently arranged blocks than those depicted in FIG. 2 and FIG. 3. Those skilled in the art will understand that the principles presented herein may be implemented in any suitably arranged processing system. Additionally, or alternatively, two or more of the blocks of method 200 and method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by an information handling system, a request for an artificial intelligence service that is associated with an artificial intelligence model;
retrieving a manifest associated with the artificial intelligence model;
determining a current system capacity of the information handling system; and
determining a workload segmentation according to the manifest based on the current system capacity of the information handling system.

2. The method of claim 1, wherein the artificial intelligence service is an artificial intelligence model inference.

3. The method of claim 1, wherein the manifest includes workload performance data based on a benchmarking process.

4. The method of claim 3, wherein the benchmarking process includes emulation of various combinations of system configuration and system capacity.

5. The method of claim 1, wherein the manifest is embedded in a model runtime plugin.

6. The method of claim 1, wherein the artificial intelligence service is executed based on the workload segmentation.

7. The method of claim 1, wherein the workload segmentation is further based on system configuration.

8. An information handling system, comprising:
a processor; and
a memory coupled to the processor, the memory having program instructions stored thereon that upon execution cause the processor to:
receive a request for an artificial intelligence service that is associated with an artificial intelligence model;
retrieve a manifest associated with the artificial intelligence model;
determine a current system capacity of the information handling system; and
determine a workload segmentation according to the manifest based on the current system capacity of the information handling system.

9. The information handling system of claim 8, wherein the artificial intelligence service is an artificial intelligence model inference.

10. The information handling system of claim 8, wherein the manifest includes workload performance data based on a benchmarking process.

11. The information handling system of claim 10, wherein the benchmarking process includes emulation of various combinations of system configuration and system capacity.

12. The information handling system of claim 8, wherein the manifest is embedded in a model runtime plugin.

13. The information handling system of claim 8, wherein the workload segmentation is further based on system configuration.

14. A non-transitory computer-readable medium to store instructions that are executable to perform operations comprising:
receiving a request at an information handling system for an artificial intelligence service that is associated with an artificial intelligence model;
retrieving a manifest associated with the artificial intelligence model;
determining a current system capacity of the information handling system; and
determining a workload segmentation according to the manifest based on the current system capacity of the information handling system.

15. The non-transitory computer-readable medium of claim 14, wherein the artificial intelligence service is an artificial intelligence model inference.

16. The non-transitory computer-readable medium of claim 14, wherein the manifest includes workload performance data based on a benchmarking process.

17. The non-transitory computer-readable medium of claim 16, wherein the benchmarking process includes emulation of various combinations of system configuration and system capacity.

18. The non-transitory computer-readable medium of claim 14, wherein the manifest is embedded in a model runtime plugin.

19. The non-transitory computer-readable medium of claim 14, wherein the artificial intelligence service is executed based on the workload segmentation.

20. The non-transitory computer-readable medium of claim 14, wherein the workload segmentation is further based on system configuration.
